(19) United States
(12) Patent Application Publication
(10) Pub. No.: US 2008/0152319 A1
(43) Pub. Date: Jun. 26, 2008

(54) APPARATUS FOR PROCESSING MULTIMEDIA STREAM AND METHOD FOR TRANSMITTING MULTIMEDIA STREAM

(75) Inventors: Chih-Hao Liang, Taipei (TW); Li-Hsiang Liao, Taipei (TW); Ching-Jan Lu, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTEK COMPUTER INC., Taipei (TW)

(21) Appl. No.: 11/960,736

(22) Filed: Dec. 20, 2007

(30) Foreign Application Priority Data
Dec. 20, 2006 (TW) 95147914

(51) Int. Cl. H04N 7/26

(52) U.S. Cl. 386/124; 386/E05.001

(57) ABSTRACT

An apparatus for processing multimedia stream and a method for transmitting multimedia stream are provided. In the present invention, a virtual capturing unit is used as a medium between a plurality of multimedia stream sources and multimedia stream destinations. The format of the multimedia stream is converted to a specific streaming format such as a video capturing source format and an audio capturing source format. The converted multimedia stream is then outputted to multimedia stream destination. Therefore, the variety of multimedia stream that the multimedia stream destination can use is increased. In addition, based on the configuration of the present invention, the program of the multimedia stream source and multimedia stream destination can be developed independently, so that the complexity of development is reduced.

### CROSS-REFERENCE TO RELATED APPLICATION

This application claims the priority benefit of Taiwan application serial no. 95147914, filed on Dec. 20, 2006. The entirety of the above-mentioned patent application is hereby incorporated by reference herein and made a part of this specification.

### BACKGROUND OF THE INVENTION

1. Field of the Invention

The invention relates to an apparatus for processing multimedia stream and a method for transmitting multimedia stream and, more particularly, to an apparatus for transmitting and processing multimedia stream between a plurality of multimedia stream sources and multimedia stream destinations and a method for transmitting multimedia stream.

2. Description of the Related Art

Along with the continuous innovation of the processing technology of multimedia stream, more and more products are related to multimedia now. Windows operating system developed by Microsoft provides a plurality of multimedia stream formats, and DirectShow provides a knock-down support for capturing and broadcasting the multimedia stream, so that data from video or audio collection cards which support the Windows driver model (WDM) can be conveniently captured by DirectShow, and related subsequent processing is done, and then the data is stored in a file. DirectShow broadly supports each type of multimedia stream format such as motion picture experts group (MPEG), audio video interleave (AVI), MPEG audio layer 3 (MP3), Wave, etc., which makes reading and broadcasting the multimedia stream be easily done.

To make the reusage convenient, Windows operating system packages operation functions such as broadcasting, compiling and transmitting multimedia stream as Directshow filters (filter for short hereinbelow), and these filters can be divided into source filters, transform filters, renderer filters, splitter filters, mux filters and so on according to their functions. Besides the above series of standard filters provided by DirectShow, developers can also develop their own filters to expand the application scope. The following takes an example to illustrate how to broadcast an AVI video file by filters.

FIG. 1 is a schematic diagram showing a conventional method for broadcasting an AVI file by filters. Please refer to FIG. 1. A conventional multimedia application software 100 utilizes a source filter 101 to read a piece of AVI streaming from a multimedia stream source (such as a hard disk 10) first, and then utilizes a splitter filter 102 to check the head file of the AVI streaming to separate the video streaming and the audio streaming of the AVI streaming. And then, a decoding filter 103 is selected to decode the video streaming according to the compressed format of the AVI streaming. Finally, a renderer filter 104 redraw the video image and transmit the video image to a graphic card 120 to display and a audio device filter 106 transmits the audio streaming to an audio card 130 to broadcast.

From the above graph, each filter is connected to one or more filters, and multimedia stream between two filters is transmitted by so-called pins, wherein arrows denote flow directions of the multimedia stream, so that a graph is a filter graph. From another aspect, a filter can be viewed as an operation interface for multimedia stream, and the filter graph describes the connection relationship among each filters. Based on the configuration, program developer only needs to add existing filters to a filter graph to combine and cooperate with self-developed filters, so that the needed application software can be developed.

However, when software developers utilize the above tools, they need to select different filters in connection with requirements for multimedia stream, and filters are connected with each other to draw a filter graph, so that a corresponding processing program can be developed. But the processing program generated by the above method can only satisfy a requirement for single multimedia stream, once the requirement for the multimedia stream is changed, the processing program needs to be amended, even to be redesigned, which greatly increases burdens of the developers. In addition, different type of multimedia stream source or multimedia stream destination devices also support different multimedia stream formats, but there are too many kinds of multimedia stream, so that how to find a suitable communication path among various kinds of the multimedia stream now has been one problem which the software developers need to solve.

### BRIEF SUMMARY OF THE INVENTION

An objective of the invention is to provide an apparatus for processing multimedia stream, and the apparatus utilizes a control interface to control a virtual capturing unit to execute operation functions such as format conversion, mixing and compilation on a plurality of multimedia stream, and then the variety of multimedia stream applications are increased. In addition, according to the requirement of each multimedia stream destination, after the format of inputted multimedia stream is converted to a specific streaming format which is supported by the corresponding multimedia stream destination, the inputted multimedia stream is outputted to the corresponding multimedia stream destination to satisfy the requirements for many kinds of multimedia stream.

To achieve the above or other objective, the invention provides an apparatus for processing multimedia stream, and the apparatus for processing multimedia stream includes a plurality of input interfaces, a plurality of output interfaces and a virtual capturing unit. Wherein each input interface is suitable to capture a piece of multimedia stream from a multimedia stream source, and each output interface is suitable to output the multimedia stream with a specific streaming format which includes one of a video capturing source format and an audio capturing source format to a multimedia stream destination. The virtual capturing unit is suitable to convert formats of the multimedia stream inputted from the input interfaces to the corresponding specific streaming formats of the output interfaces and transmit the converted multimedia stream to the output interfaces to output.

The apparatus for processing multimedia stream in a preferred embodiment of the invention further includes a control interface which is suitable to control the virtual capturing unit to execute an operation function on the multimedia stream inputted from the input interface, and the operation function includes one of format conversion, mixing and compilation for the multimedia stream.

In the apparatus for processing multimedia stream of a preferred embodiment of the invention, the multimedia stream source includes one of a television, a movie and a piece of music, and the multimedia stream destination includes one of a network, a display device and a storage device.

In the apparatus for processing multimedia stream of a preferred embodiment of the invention, the specific streaming format comprises defining one or combination of the image size, the color and the sampling rate of the multimedia stream.

The invention further provides a method for transmitting multimedia stream, and the method includes designing a first graph which includes a plurality of input interfaces, and each input interface is corresponding to a multimedia stream source and suitable to capture a piece of multimedia stream. And then a second graph is designed and includes a plurality of output interfaces each of which is corresponding to a multimedia stream destination and suitable to output the multimedia stream. Finally, a virtual capturing unit is provided, and the virtual capturing unit is connected to the input interfaces of the first graph and the output interfaces of the second graph, respectively, and is suitable to convert formats of the multimedia stream inputted by the input interfaces to a corresponding specific streaming format of each of the output interfaces and transmit the multimedia stream to the output interfaces to output.

A method for transmitting multimedia stream according to a preferred embodiment of the invention further includes designing a control interface which is connected to the virtual capturing unit and is suitable to control the virtual capturing unit to execute an operation function on the multimedia stream inputted from the input interfaces.

A method for transmitting multimedia stream according to a preferred embodiment of the invention further includes replacing the input interface that the multimedia stream source corresponds to when the multimedia stream source in the first graph is changed and replacing the output interface that the multimedia stream destination corresponds to when the multimedia stream destination in the second graph is changed.

Then invention utilizes a virtual capturing unit as a media between multimedia stream sources and multimedia stream destinations to convert the format of the multimedia stream to a specific streaming format such as a video capturing source format or an audio capturing format, and transmit the multimedia stream to a multimedia stream destination, so that multimedia stream that the multimedia stream destination can use are further various. Based on the configuration of the present invention, codes of multimedia stream sources and multimedia stream destinations can be developed independently, so that the complexity of development is reduced.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is a schematic diagram showing a conventional method for broadcasting an audio video interleave (AVI) file by filters.

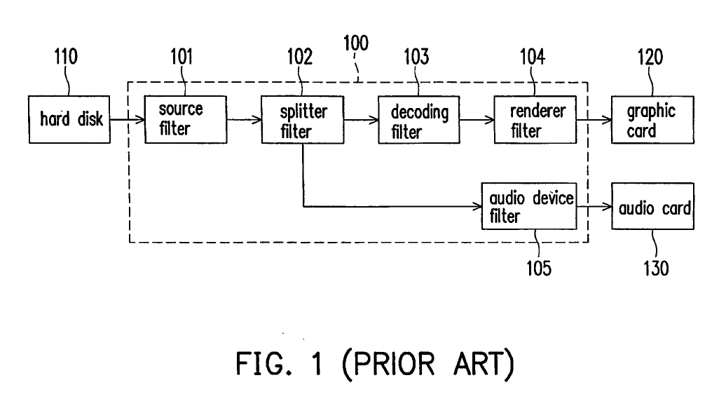

FIG. 2 is a block diagram showing an apparatus for processing multimedia stream according to the first embodiment of the invention.

FIG. 3 is a flow chart showing a method for transmitting multimedia stream according to the first embodiment of the invention.

FIG. 4 is a block diagram showing an apparatus for processing multimedia stream according to the second embodiment of the invention.

FIG. 5 is a flow chart showing a method for transmitting multimedia stream according to the second embodiment of the invention.

FIG. 6 is a block diagram showing an apparatus for processing multimedia stream according to the third embodiment of the invention.

FIG. 7 is a flow chart showing a method for transmitting multimedia stream according to the fourth embodiment of the invention.

### DETAILED DESCRIPTION OF THE EMBODIMENTS

Various types of multimedia stream can have different corresponding operation functions and part codes of the operation functions are possible to be the same or similar. The invention utilizes the above feature to enable operation functions which originally need to be individually developed to reuse developed codes, and utilizes a set of operation devices to integrate the operation functions of various types of multimedia stream, so that burdens of developing application software can be reduced. To make the content of the invention more detailed, the following takes embodiments to verify that the invention can be carried out.

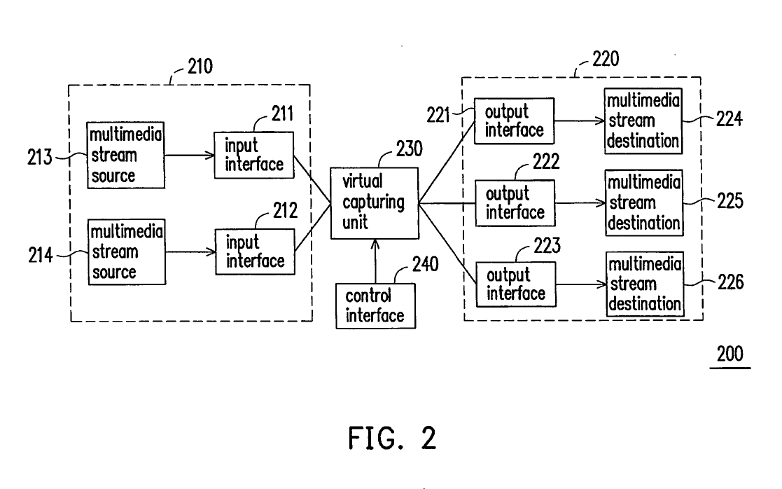

FIG. 2 is a block diagram showing an apparatus for processing multimedia stream according to the first embodiment of the invention. Please refer to FIG. 2, and an apparatus for processing multimedia stream 200 includes an input module 210, an output module 220, a virtual capturing unit 230 and a control interface 240. The input module 210 includes multimedia stream sources 213 and 214, input interfaces 211 and 212, and the output module 220 includes output interfaces 221, 222 and 223 and multimedia stream destinations 224, 225 and 226. If the multimedia stream provided by the multimedia stream source 213 or 214 is directly transmitted to the multimedia stream destination 224, 225 or 226, the multimedia stream cannot be recognized by the multimedia stream destinations 224, 225 or 226 because of the incompatible format. Therefore, the apparatus for processing multimedia stream 200 acts as a role for transmitting the multimedia stream and is in charge of enabling the multimedia stream destination 224, 225 or 226 to “recognize” the multimedia stream provided by the multimedia stream source 213.

The input interfaces 211 and 212 are used to receive the multimedia stream from the multimedia stream sources 213 and 214, respectively. Taking the DirectShow of Windows operating system as an example, the apparatus for processing multimedia stream 200 needs to register a corresponding filter as the input interface (211 or 212) according to the type of the multimedia stream source (213 or 214) and is in charge of transmitting the received multimedia stream to the virtual capturing unit 230 to process. Wherein the multimedia stream sources 213 and 214 are, for example, televisions, movies, music and so on, but it is not limited.

The output interfaces 221, 222 and 223 are used to output the multimedia stream which has a specific streaming format after processed by the virtual capturing unit 230 to the multimedia stream destinations 224, 225 or 226. In the embodiment, the type of the output interfaces 221, 222 and 223 mainly is the type of a video capturing source and an audio capturing source, and therefore, filters of the type of the video capturing source and the audio capturing source need to be registered in Windows operating system, but the type of the above output interfaces are only used to conveniently illustrate and not used to limit the scope thereof. In other words, the virtual capturing unit 230 can provide multimedia stream according to the specific streaming format supported by the output interface (221, 222 or 223) and then the output interface (221, 222 or 223) outputs the multimedia stream to the multimedia stream destination (224, 225 or 226).

The multimedia stream destination can be a network (such as instant communication software), a display device (such as a screen), a storage device (such as a hard disk) and so on. The specific streaming format includes defining one or combination of the image size, the color and the sampling rate of the multimedia stream. The above multimedia stream destination and the specific streaming format are only an example used to illustrate and do not limit the scope thereof.

The virtual capturing unit 230 can convert the format of the multimedia stream inputted by the input interface (211 or 212) according to the specific streaming format supported by the output interface (221, 222 or 223) and then transmits the multimedia stream to the output interface (221, 222 or 223) to output. In other words, the format of the multimedia stream inputted by the input interface (211 or 212) is converted to the format which can be outputted by the output interface (221, 222 or 223).

For example, if the specific streaming format needed by the output interface 221 is a YUY2 format, and the format of the multimedia stream received by the input interface 211 from the multimedia stream source 213 is the RGB format, the virtual capturing unit 230 needs to convert the format of the multimedia stream inputted by the input interface 211 from the RGB format to the YUY2 format, and then the converted multimedia stream is transmitted to the output interface 221 to output. In this way, the multimedia stream destination 224 can recognize the multimedia stream.

The control interface 240 controls the virtual capturing unit 230 to execute an operation function on the multimedia stream inputted by the input interface 211 or 212. In other words, the control interface 240 is similar to a user interface for a user to send a control command to the virtual capturing unit 230 to execute the operation function, which makes the apparatus for operating the multimedia stream 200 have greater elasticity of usage. The above operation function also includes mixing and compilation of the multimedia stream besides converting the format of the multimedia stream to a specific streaming format, but it is not limited.

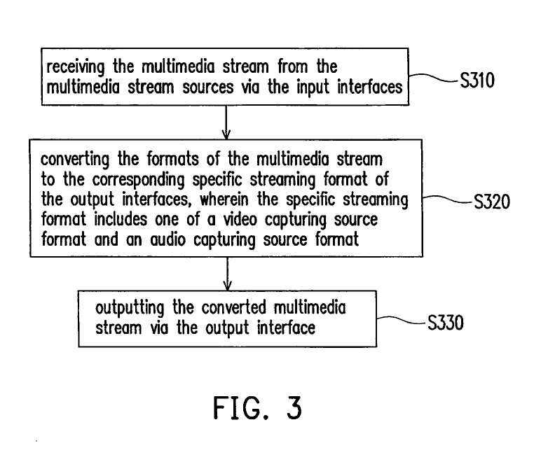

To further clearly illustrate the process for processing the multimedia stream by the above apparatus for processing multimedia stream, the following takes another flow chart as an example to illustrate. FIG. 3 is a flow chart showing a method for transmitting multimedia stream according to the first embodiment of the invention. Please refer to FIG. 2 and FIG. 3 simultaneously, and in the embodiment, the multimedia stream is received via the input interfaces 211 and 212 from the multimedia stream sources 213 and 214 first (step S310), wherein each input interface is corresponding to a multimedia stream source which includes a television, a movie, music and so on, but it is not limited.

Next, the formats of the multimedia stream are converted to the corresponding specific streaming formats of the output interfaces 221, 222 and 223 (step S320), wherein the specific streaming formats can be, for example, a video capturing source format or an audio capturing source format, and the content of the specific streaming formats includes defining one or combination of the image size, the color and the sampling rate of the multimedia stream, but it is not limited.

Finally, the converted multimedia stream is transmitted to the corresponding multimedia stream destination 224, 225 or 226 via the output interface 221, 222 or 223 (step S330). Wherein the multimedia stream destinations can be, for example, a network, a display device or a storage device, but it is not limited.

Before the output interfaces 221, 222 and 223 output the multimedia stream, the user can utilize the control interface 240 to execute operation functions such as format conversion, mixing or compilation on the multimedia stream received by the input interface 211 and 212. For example, supposing that two multimedia stream sources input a piece of video streaming, respectively, the user can select one piece of the video streaming as the data of a main picture and make the other piece of video streaming as the data of a sub-picture, and then the control interface selects to mix the two pieces of the video streaming into a piece of video streaming including picture-in-picture (PIP) to output.

Certainly, the user can also utilize the control interface 240 to make a piece of multimedia stream outputted to different multimedia stream destinations (224, 225 or 226) via different input interfaces (221, 222 or 223), respectively. For example, if a piece of audio and video streaming is inputted from a multimedia stream source, the user can utilize the control interface to divide the audio and video streaming to two parts, namely, video streaming and audio streaming, and then the video streaming and the audio streaming are outputted to multimedia stream destinations such as a screen and a loudspeaker, respectively, via a video interface and an audio interface.

To sum up, since the apparatus for processing multimedia stream of the invention acts as not only a role for transmitting multimedia stream but also an operation unit of the multimedia stream, the application software can be provided to develop the application function in a higher level, wherein the input interfaces 211 and 212, the output interfaces 221, 222 and 223, and the control interface 240 can be obtained by registering a filter in Windows operating system, which makes the invention have greater elasticity of usage. In the embodiment, the input module 210 and the output module 220 of the apparatus for processing multimedia stream can be separately designed, and they are drawn as one graph, respectively, and corresponding input interfaces and output interfaces are provided therein. If the multimedia stream source or the multimedia stream destination is changed, only components of one graph need to be replaced, and the operation of the other graph is not affected, so that the reutilization rate of the codes can be increased.

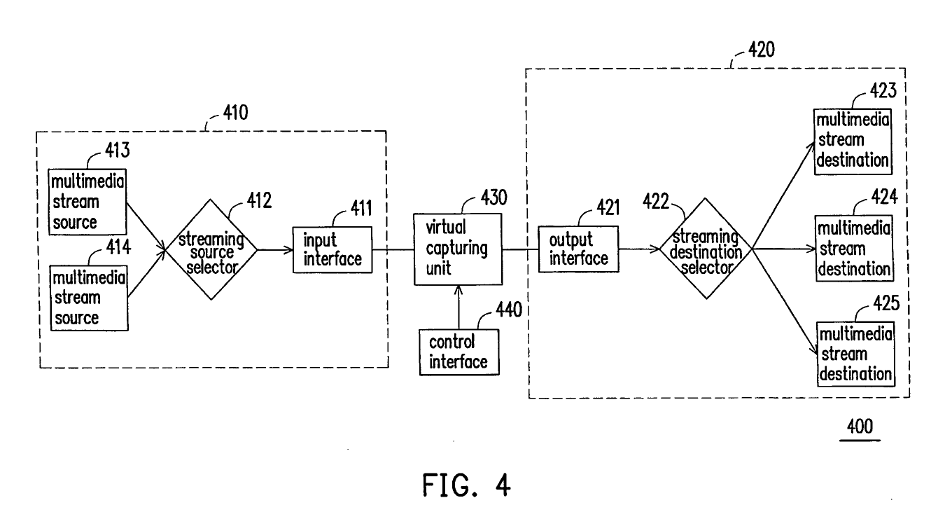

FIG. 4 is a block diagram showing an apparatus for processing multimedia stream according to the second embodiment of the invention. Please refer to FIG. 4, and an apparatus for processing multimedia stream 400 includes an input module 410, an output module 420, a virtual capturing unit 430 and a control interface 440. The input module 410 includes an input interface 411, a streaming source selector 412 and multimedia stream sources 413, 414, and the output module 430 includes an output interface 421, a streaming destination selector 422 and multimedia stream destinations 423, 424, 425. Since functions of the input interface 411, output interface 421 and the virtual capturing unit 430 are the same with or similar to functions of the input interfaces 211, 212, output interfaces 221, 222 and 223, and the virtual capturing unit 230 of the apparatus for processing multimedia stream 200 in the first embodiment (please refer to FIG. 2), they are not described herein for concise purpose.

Please go on referring to FIG. 4, and compared with the first embodiment, the embodiment further includes a selection mechanism for the multimedia stream sources and the multimedia stream destinations, and the control interface 440 is further utilized to control the virtual capturing unit 430 to execute operation functions on the multimedia stream inputted from the input interface 411. In other words, the control interface 440 which is similar to a user interface is provided for the user to send a command to the virtual capturing unit 430 to execute the operation functions, which makes the apparatus for processing multimedia stream 400 have great elasticity of usage. The above operation function also includes mixing and compilation of the multimedia stream besides converting the format of the multimedia stream to a specific streaming format, but it is not limited.

In the embodiment, two multimedia stream sources 413 and 414 and three multimedia stream destinations 423, 424 and 425 are provided, and a streaming source selector 412 and a streaming destination selector 422 are further provided. The streaming source selector 412 is used to select between the multimedia stream source 413 and the multimedia stream source 414, and only one of the multimedia stream sources 413 and 414 is provided to the input interface 411. In other words, the streaming source selector 412 selects a multimedia stream source to provide multimedia stream according to the multimedia stream that the input interface 411 wants to receive; similarly, the streaming destination selector 422 selects among the multimedia stream destinations 423, 424 and 425, and the multimedia stream is only outputted to one multimedia stream destination.

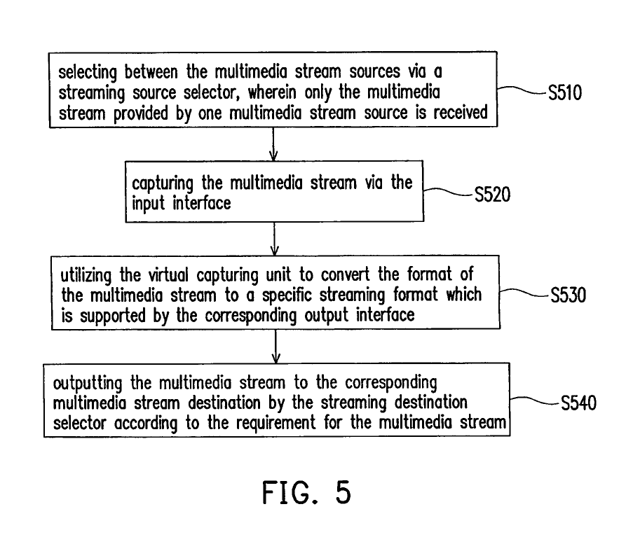

FIG. 5 is a flow chart showing a method for transmitting multimedia stream according to the second embodiment of the invention. The following further illustrates detailed steps of the method for transmitting multimedia stream of the invention with the configuration diagram of the above apparatus for processing multimedia stream. Please refer to FIG. 4 and FIG. 5 simultaneously. In the embodiment, the streaming source selector 412 is used to select between the multimedia stream sources 413 and 414 first, and only the multimedia stream provided by one multimedia stream source (413 or 414) is received (step S510). Wherein the multimedia stream source is streaming data of, for example, a television, a movie or music, but it is not limited.

Next, the input interface 411 receives the multimedia stream from the multimedia stream source (413 or 414) selected by the streaming source selector 412 (step S520), and the multimedia stream is transmitted to the virtual capturing unit 430 to be processed.

And then, the virtual capturing unit 430 converts the format of the multimedia stream inputted from the streaming source selector 412 to a specific streaming format which is supported by the corresponding multimedia stream destination (423, 424 or 425) (step S530), and the specific streaming format is, for example, a video capturing source format or an audio capturing source format.

After the format of the multimedia stream is converted, the multimedia stream is outputted by the output interface 421, and the streaming destination selector 422 can output the multimedia stream to the corresponding multimedia stream destination (423, 424 or 425) according to the previously proposed requirement for the multimedia stream (step S540).

For example, supposing that the multimedia stream sources 413 and 414 are a television tuner and a digital video disk (DVD) projector, respectively, and the multimedia stream destinations 423, 424 and 425 are instant communication software, a hard disk and a screen, respectively. Wherein if the user wants to make the screen display a television picture, the streaming source selector 412 is used to select the television tuner from the television tuner and the DVD projector to receive the multimedia stream first, and the multimedia stream is inputted to the virtual capturing unit 430 via the input interface 411 to convert its format. If the inputted multimedia stream is television streaming of National Television Standards Committee (NTSC) format and the screen can support the YUY2 format, the virtual capturing unit 430 needs to convert the format of the multimedia stream from the NTSC format to the YUY2 format and then transmit the multimedia stream to the output interface 421 to output. At this time, the streaming destination selector 422 selects the screen, and the multimedia stream outputted by the output interface 421 is transmitted to the screen to display, and then the whole flow path for operating the multimedia stream of the embodiment of the invention is completed.

To sum up, in the embodiment, the input module 410 and the output module 420 can be considered as independent graphs, if the developed application software includes two parts which are a multimedia stream source and a multimedia stream destination, program developers can independently develop the input module 410 and the output module 420, respectively, with the cooperation of virtual capturing unit 430. Once one part needs to be changed, the other part does not need to be changed, so that the reutilization rate of codes can be greatly increased.

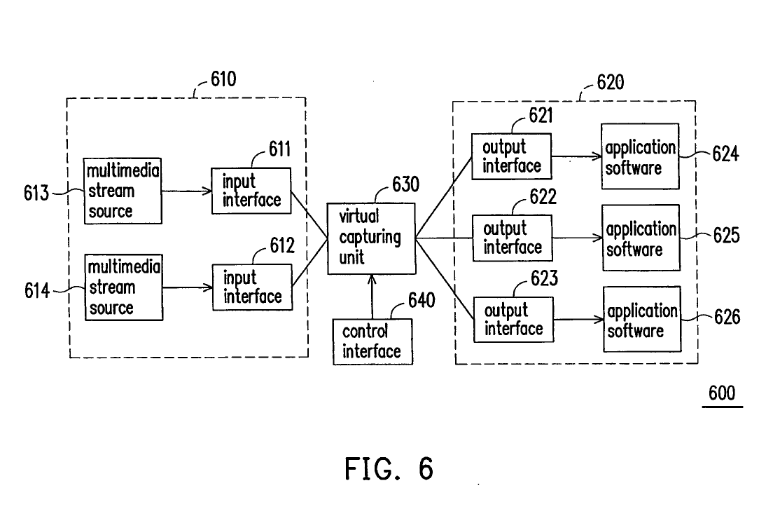

FIG. 6 is a block diagram showing an apparatus for processing multimedia stream according to the third embodiment of the invention. Please refer to FIG. 6, and in the embodiment, an apparatus for processing multimedia stream 600 includes an input module 610, an output module 620, a virtual capturing unit 630 and a control interface 640. Wherein the input module 610 further includes input interfaces 611, 612, multimedia stream sources 613, 614, and the output module 620 includes output interfaces 621, 622, 623, application software 624, 625, 626, and the output interfaces 621, 622, 623 are video and audio capturing source filters which are registered in Windows operating system, respectively.

In the embodiment, the multimedia stream is packaged in video and audio capturing source modes, and this concept comes from some application software which only includes the part of the application of the multimedia stream destination of the above embodiment, and the above application software does not care where the multimedia stream comes from and only read multimedia stream with a specific format in connection with a specific type of interfaces (for example, the output interfaces 621, 622 and 623) which are usually filters in video capturing source type or audio capturing source type. Therefore, if the qualified multimedia stream is outputted through these types of interfaces, the application software can be utilized to operate the multimedia stream without caring where the multimedia stream are generated. The above feature can make the usage scope of the application software expanded. Since the application software has included the part of multimedia stream destination, only the multimedia stream source needs to be replaced, and the apparatus for processing multimedia stream 600 is further provided, so that various multimedia stream can be provided.

For example, at present, when utilizing instant communication software (for example, MSN messenger) to make a video talk, a user needs to set devices of video and audio capturing sources (such as a web camera and a microphone) first, and then the video or audio streaming captured by these devices is transmitted to another party. However, the above method limits the function of the instant communication software, so that the instant communication software cannot further transmit or broadcast other types of multimedia stream. When the configuration of the invention is utilized, it only needs to make the multimedia stream inputted by various multimedia stream sources (for example, a television tuner, a stereo, a MP3 broadcaster, and so on) converted to the multimedia stream in the video or audio capturing source type via the virtual capturing unit, and the multimedia stream can satisfy the requirement of the instant communication software and can be considered as the multimedia stream captured by a common web camera or a microphone, so that the multimedia stream sources which can be received by the instant communication software can be increased, and the variety of the instant communication software can be increased.

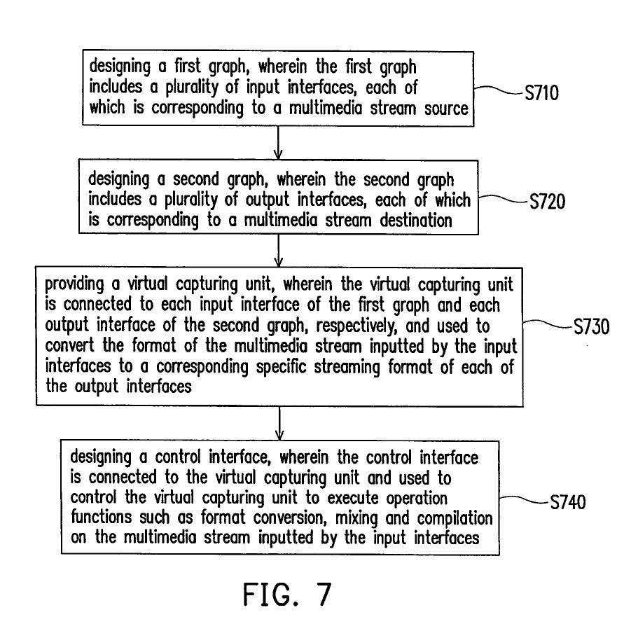

FIG. 7 is a flow chart showing a method for transmitting multimedia stream according to the fourth embodiment of the invention. Please refer to FIG. 7, and the configuration of the embodiment is based on that of the first embodiment, and a program of an apparatus for processing multimedia stream is provided for software designers.

First, a user can design a first graph first, and the first graph includes a plurality of input interfaces each of which is corresponding to a multimedia stream source (step S710). Therefore, multimedia stream can be captured from the multimedia stream sources, respectively, and the multimedia stream is, for example, a television, a movie or music, but it is not limited.

Next, a second graph is designed and includes a plurality of output interfaces each of which is corresponding to a multimedia stream destination (step S720). The above multimedia stream is outputted to the corresponding multimedia stream destination which is, for example, a network, a display device or a storage device, but it is not limited.

And then, a virtual capturing unit is provided and is connected to each input interface of the first graph and each output interface of the second graph, respectively, to convert the format of the multimedia stream inputted by the input interfaces to a corresponding specific streaming format of each of the output interfaces, and the multimedia stream is transmitted to the output interfaces to be outputted (step S730).

In addition, a control interface can be further designed and is connected to the virtual capturing unit, and the control interface is used to control the virtual capturing unit to execute operation functions such as format conversion, mixing and compilation on the multimedia stream inputted by the input interfaces (step S740). Wherein the above input interface, output interface and control interface are filters which are registered in Windows operating system.

In the apparatus for processing multimedia stream, which is designed out by the method of the embodiment, the first graph and the second graph are separately designed, so that if the multimedia stream source in the first graph is changed, only the input interface corresponding to the changed multimedia stream source needs to be replaced, and other parts are not affected. Similarly, if the multimedia stream destination in the second graph is changed, only the output interface corresponding to the changed multimedia stream destination needs to be replaced. In addition, the above flow path is just as an example, and its sequence is not limited, and the user can change the flow path of the method for transmitting according to actual requirements.

To sum up, the apparatus for processing multimedia stream and the method for transmitting multimedia stream of the invention have at least the following features.

First, a virtual capturing unit is utilized as the media between a multimedia stream source and a multimedia stream destination, so that the multimedia stream destination can receive multimedia stream provided by various multimedia stream source, and the variety of the multimedia stream application is increased;

Second, functions such as format conversion, mixing and compilation can be executed in connection with multimedia stream from different sources, and the processed multimedia stream can be outputted to one or more multimedia stream destinations to increase the elasticity of usage of the apparatus for processing multimedia stream;

Third, the multimedia stream source and the multimedia stream destination can be independently developed, and if their application needs to be changed, only one party is needed to adjusted, so that the reutilization rate of codes is increased.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An apparatus for processing multimedia stream, the apparatus comprising:
an input module comprising a plurality of input interfaces, each of which is suitable to capture a multimedia stream from a multimedia stream source;
an output module comprising a plurality of output interfaces, each of which is suitable to output the multimedia stream with a specific streaming format to a multimedia stream destination; and
a virtual capturing unit which is suitable to convert formats of the multimedia stream inputted from the input interfaces to the specific streaming format that each of the output interfaces corresponds to and transmit the multimedia stream to the output interfaces to output.

2. The apparatus for processing multimedia stream according to claim 1, the apparatus further comprising:
a control interface which is suitable to control the virtual capturing unit to execute an operation function on the multimedia stream inputted from the input interfaces.

3. The apparatus for processing multimedia stream according to claim 2, wherein the operation function comprises one of format conversion, mixing and compilation for the multimedia stream.

4. The apparatus for processing multimedia stream according to claim 1, wherein the multimedia stream source comprises one of a television, a movie and music.

5. The apparatus for processing multimedia stream according to claim 1, wherein the multimedia stream destination comprises one of a network, a display device and a storage device.

6. The apparatus for processing multimedia stream according to claim 1, wherein the specific streaming formats comprise defining one or combination of the image size, the color and the sampling rate of the multimedia stream.

7. The apparatus for processing multimedia stream according to claim 1, wherein the specific streaming format comprises one of a video capturing source format and an audio capturing source format.

8. The apparatus for processing multimedia stream according to claim 1, wherein the input interfaces and the output interfaces are filters which are registered in the Windows operating system.

9. A method for transmitting multimedia stream, the method comprising the following steps:
designing a first graph comprising a plurality of input interfaces, each of which is corresponding to a multimedia stream source and suitable to capture a multimedia stream;
designing a second graph comprising a plurality of output interfaces, each of which is corresponding to a multimedia stream destination and suitable to output the multimedia stream; and
providing a capturing unit which is connected to the input interfaces of the first graph and the output interfaces of the second graph, respectively, and is suitable to convert formats of the multimedia stream inputted by the input interfaces to a specific streaming format that each of the output interfaces corresponds to and transmit the multimedia stream to the output interfaces to output.

10. The method for transmitting multimedia stream according to claim 9, the method further comprising:
designing a control interface which is connected to the virtual capturing unit and is suitable to control the virtual capturing unit to execute an operation function on the multimedia stream inputted from the input interfaces.

11. The method for transmitting multimedia stream according to claim 10, wherein the input interfaces and the output interfaces are a filter which is registered in the Windows operating system.

12. The method for transmitting multimedia stream according to claim 10, wherein the operation function comprises one of format conversion, mixing and compilation for the multimedia stream.

13. The method for transmitting multimedia stream according to claim 9, the method further comprising:
replacing the input interface corresponding to the multimedia stream source when the multimedia stream source in the first graph is changed.

14. The method for transmitting multimedia stream according to claim 9, the method further comprising:
replacing the output interface corresponding to the multimedia stream destination when the multimedia stream destination in the second graph is changed.

15. The method for transmitting multimedia stream according to claim 9, wherein the multimedia stream source comprises one of a television, a movie and music.

16. The method for transmitting multimedia stream according to claim 9, wherein the multimedia stream destination comprises one of a network, a display device and a storage device.

17. The method for transmitting multimedia stream according to claim 9, wherein the specific streaming formats comprise defining one or combination of the image size, the color and the sampling rate of the multimedia stream.
